(19) United States
(12) Patent Application Publication
(10) Pub. No.: US 2017/0060100 A1
(43) Pub. Date: Mar. 2, 2017

(54) SMART WATCH

(71) Applicant: ASUSTEK COMPUTER INC., TAIPEI (TW)

(72) Inventors: Wean-Fong LOI, TAIPEI (TW); Yue-Hin KONG, TAIPEI (TW); Ee-Fun TEO, TAIPEI (TW)

(21) Appl. No.: 15/247,277

(22) Filed: Aug. 25, 2016

Related U.S. Application Data
(60) Provisional application No. 62/209,894, filed on Aug. 26, 2015.

(30) Foreign Application Priority Data
Aug. 2, 2016 (TW) 105124450

(51) Int. Cl. G04G 21/08; G06F 3/0484; G06F 3/0488; G06F 1/16; G06F 3/0483

(52) U.S. Cl. CPC G04G 21/08; G06F 1/163; G06F 1/1692; G06F 3/0483; G06F 3/0488; G06F 3/04845; G06F 2203/04806

(57) ABSTRACT

A smart watch including a watch body, a plurality of the sensors, and a processing unit is provided. A watch body including an upper surface, the upper surface includes a display portion and an outer portion. The display portion displays a first functional page of the functional pages. The outer portion is configured at periphery of the display portion and includes a plurality of sensing areas. The sensors are correspondingly configured at each of the sensing areas. When the sensors sense that at least one of the sensing areas is touched along a first clockwise track or a first counter-clockwise track, a touch signal is transmitted. The processing unit is configured at the watch body and electrically connected to the sensors. The processing unit receives the touch signal and changes the first functional page accordingly.

### CROSS-REFERENCE TO RELATED APPLICATION

This application claims the priority benefit of U.S. provisional application Ser. No. 62/209,894, filed on Aug. 26, 2015 and TW application serial No. 105124450, filed on Aug. 2, 2016. The entirety of the above-mentioned patent applications are hereby incorporated by reference herein and made a part of specification.

### BACKGROUND OF THE INVENTION

Field of the Invention

The invention relates to a watch and, more particularly, to a smart watch.

Description of the Related Art

A smart watch is configured small for easy wear. However, a screen on the smart watch is also small. Therefore, it is not easily to operate on the screen. For example, in a conventional smart watch, applications (APP) are shown in a list or a folder (which is called as a functional page hereinafter), to select a target application, the functional pages are switched via touches or certain gestures to execute the applications, which is rather inconvenient.

### BRIEF SUMMARY OF THE INVENTION

A smart watch including a watch body, a plurality of the sensors, and a processing unit is provided. A watch body including an upper surface, the upper surface includes a display portion and an outer portion. The display portion displays a first functional page of the functional pages.

The outer portion is configured at periphery of the display portion and includes a plurality of sensing areas. The sensors are correspondingly configured at each of the sensing areas. When the sensors sense that at least one of the sensing areas is touched along a first clockwise track or a first counter-clockwise track, a touch signal is transmitted. The processing unit is configured at the watch body and electrically connected to the sensors. The processing unit receives the touch signal and changes the display on the display portion accordingly.

In sum, when the user operates on the sensing areas of the smart watch, the functional pages can be changed according to the sensed track on the sensing areas. Consequently, the operation is more intuitive, simple, and convenient.

### BRIEF DESCRIPTION OF THE DRAWINGS

These and other features, aspects and advantages of the invention will become better understood with regard to the following embodiments and accompanying drawings.

FIG. 1 is a top view of a smart watch in an embodiment;

FIG. 2 is a section view of a smart watch in an embodiment;

FIG. 3 is a block diagram of a smart watch in an embodiment;

FIG. 4 and FIG. 4A are schematic diagrams showing that sensing areas are touched along a first clockwise track in an embodiment;

FIG. 5 and FIG. 5A are schematic diagrams showing that sensing areas are touched along a first clockwise track in an embodiment;

FIG. 6 and FIG. 6A are schematic diagrams showing that sensing areas are touched along a first counter-clockwise track in an embodiment;

FIG. 7, FIG. 7A, and FIG. 7B are schematic diagrams showing that sensing areas are touched along a first clockwise track and a second clockwise track in an embodiment;

FIG. 8, FIG. 8A, and FIG. 8B are schematic diagrams showing that sensing areas are touched along a first counter-clockwise track and a second counter-clockwise track in an embodiment;

FIG. 9 and FIG. 9A are schematic diagrams showing that a trigger unit is triggered along a moving direction in an embodiment;

FIG. 10 is a top view of a smart watch in an embodiment;

FIG. 11 is a block diagram showing a smart watch in an embodiment;

FIG. 12, FIG. 12A, and FIG. 12B are schematic diagrams showing that the touch moves to the application input portion along a clockwise operation track and continuously moves to the operation destination portion in an embodiment;

FIG. 13, FIG. 13A, and FIG. 13B are schematic diagrams showing that the touch moves to the application setting portion along the counter-clockwise operation track and continuously moves to the operation destination portion in an embodiment;

FIG. 14 is a top view of a smart watch in an embodiment;

FIG. 15 is a block diagram showing a smart watch in an embodiment;

FIG. 16, FIG. 16A, and FIG. 16B are schematic diagrams showing that the touch moves to the operation end point of the outer portion along the clockwise operation track, and then moves to the operation destination portion in an embodiment;

FIG. 17, FIG. 17A, and FIG. 17B are schematic diagrams showing that the touch moves to the operation end point of the outer portion along the counter-clockwise operation track, and then moves to the operation destination portion in an embodiment; and

FIG. 18 and FIG. 18A is a schematic diagram showing the time setting in an embodiment.

### DETAILED DESCRIPTION OF THE EMBODIMENTS

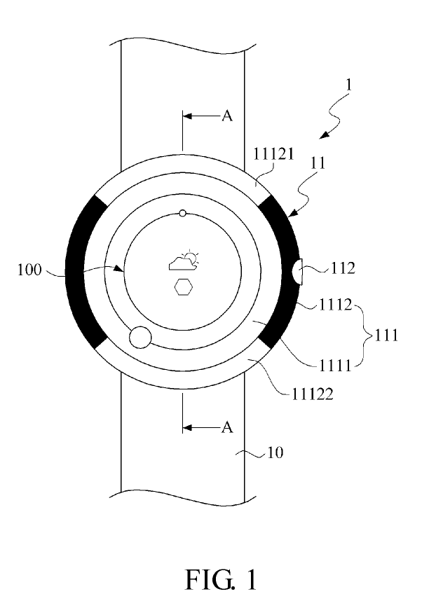

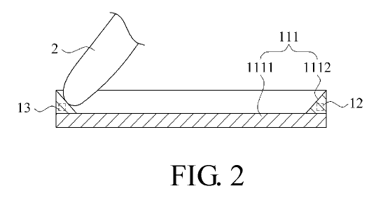

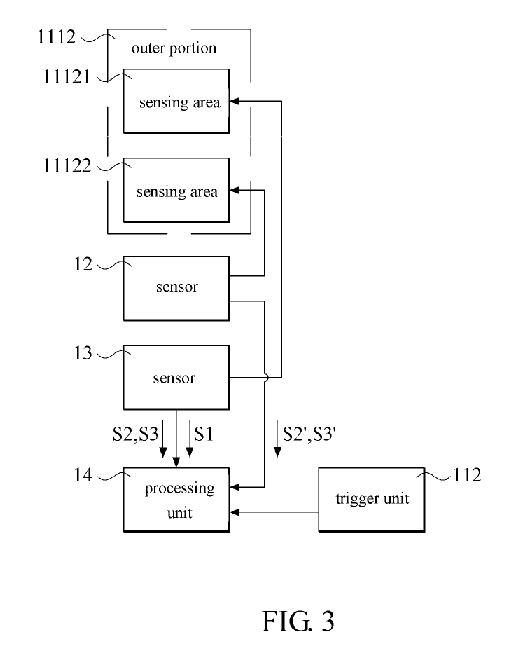

Please refer to FIG. 1 to FIG. 3. FIG. 1 is a top view of a smart watch in an embodiment. FIG. 2 is a section view of a smart watch in an embodiment. FIG. 3 is a block diagram of a smart watch in an embodiment.

In an embodiment, a smart watch 1 is a wrist watch. The smart watch 1 includes a watchband 10, a watch body 11, a plurality of sensors (only two sensors 12 and 13 are shown, which is not limited herein) and a processing unit 14. The watch body 11 includes an upper surface 111, and a trigger unit 112 is configured at a side wall of the watch body 11.

The upper surface 111 includes a display portion 1111 and an outer portion 1112, and the display portion 1111 is used to display a first functional page 100 of a plurality of operational pages (not shown). The functional page herein is a display of selected target application. The operational page is a message page, a calendar page, a weather page, an original home page, a music page, a setting page, or a page for an application, which is not limited herein. In the embodiment, the first functional page 100 is a weather page. In an embodiment, the trigger unit 112 is a crown which is rotatable and can push and pull, which is not limited herein.

The outer portion 1112 locates at a periphery of the display portion 1111, that is, the outer portion 1112 surrounds the display portion 1111, and a plurality of sensing areas (only two sensing areas 11121 and 11122 are shown in the embodiment), and the sensing areas 11121 and 11122 are configured at upper and lower sides of the watch body 11.

In an embodiment, the outer portion 1112 is a bezel and has a height higher than that of the display portion 1111, and the height of the bezel is gradually decreased from an outer edge of the outer portion 1112 towards an inner edge of the outer portion 1112 till the height of the inner edge of the outer portion 1112 is the same as that of the display portion 1111 (as shown in FIG. 2), and then the user would not mistakenly slide fingers to the outer edge of the outer portion 1112.

The sensors 12 and 13 are configured at the sensing areas 11121 and 11122. The sensors 12 are configured corresponding to the sensing areas 11122, and the sensor 13 is configured corresponding to the sensing areas 11121. The sensors are configured in a way, for example, by embedding under the sensing areas 11121 and 11122 (as shown in FIG. 2).

The processing unit 14 is configured at the watch body 11 and electrically connected to the trigger unit 112 and the sensors 12, 13. In an embodiment, the processing unit 14 is a processor with a processing function and a memory function, such as one or a combination of a central processing unit (CPU), a graphics processing unit (GPU), and an accelerated processing unit, which is not limited herein.

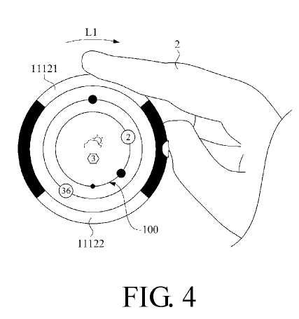

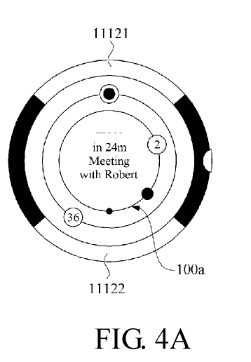

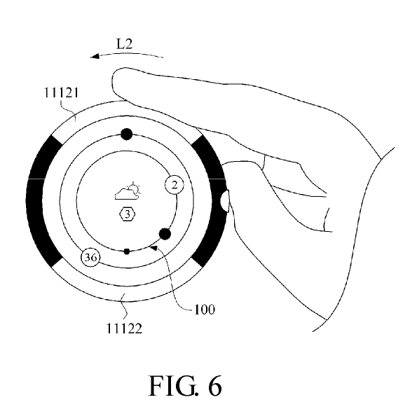

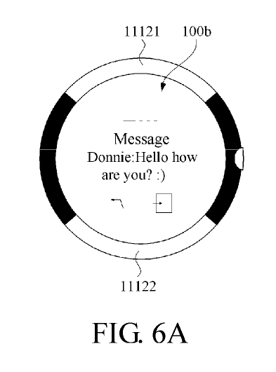

The sensors 12 and 13 transmit a touch signal S1 when a touch at the sensing areas 11121 and 11122 along a first clockwise track L1 (as shown in FIG. 4) or a first counter-clockwise track L2 (as shown in FIG. 6) is sensed. The processing unit 14 receives the touch signal S1 and changes the first functional page 100 accordingly.

Please refer to FIG. 4. FIG. 4 and FIG. 4A are schematic diagrams showing that sensing areas are touched along a first clockwise track in an embodiment. As shown in FIG. 4 and FIG. 4A, the object 2 (such as a finger or a stylus) touches the sensing area 11121 along the first clockwise track L1, after the processing unit 14 receives the touch signal S1, the display portion 1111 displays a second functional page 100a of the operational pages, instead of the first functional page 100. In an embodiment, the second functional page 100a is a calendar page.

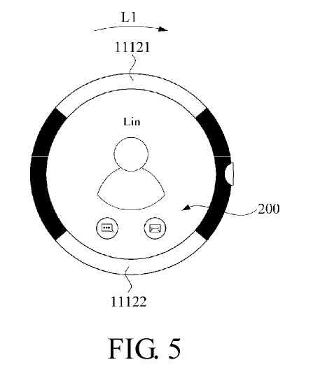

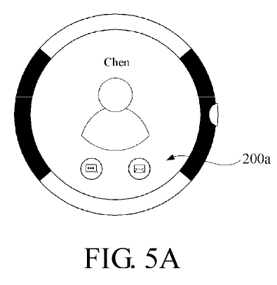

FIG. 5 and FIG. 5A are schematic diagrams showing that sensing areas are touched along a first clockwise track in an embodiment. As shown in FIG. 5 and FIG. 5A, the first functional page 200 is a contact page, when the object 2 touches the sensing area 11121 along the first clockwise track L1, the processing unit 14 changes the first functional page 200 to the second functional page 200a on the display portion 1111. In an embodiment, the second functional page 200a is another contact page which has different contact information from that of the first functional page 200.

FIG. 6 and FIG. 6A are schematic diagrams showing that sensing areas are touched along a first counter-clockwise track in an embodiment. The object 2 touches the sensing area 11121 along the first counter-clockwise track L2, after the processing unit 14 receives the touch signal S1, the display portion 1111 is changed by the processing unit 14 from the first functional page 100 to the second functional page 100b. In an embodiment, the second functional page 100b is a message page.

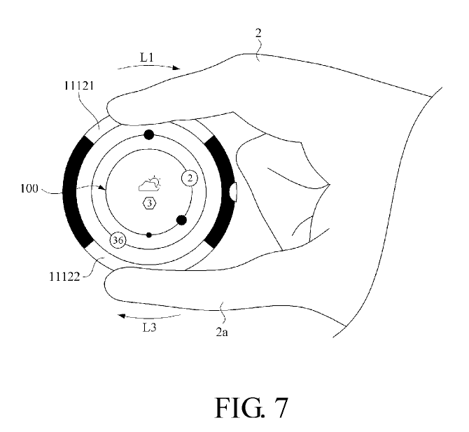

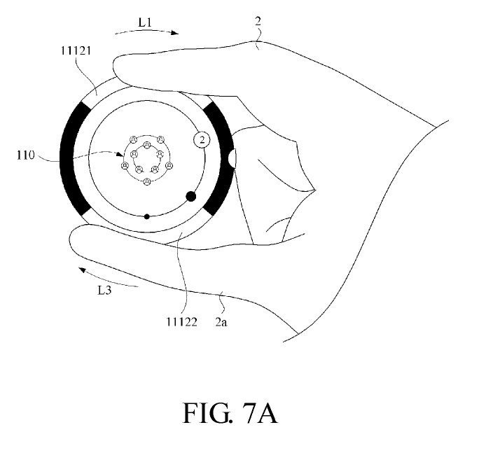

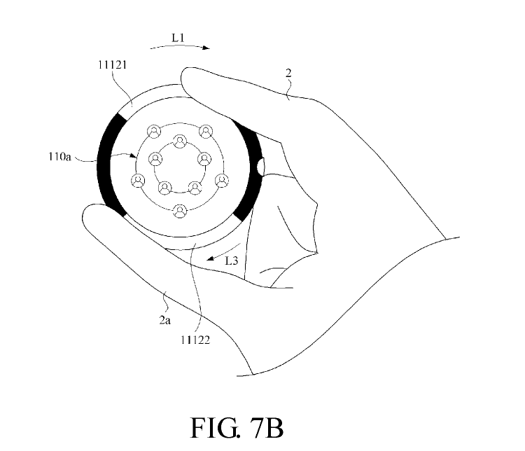

In an embodiment, when the sensors 12 and 13 sense that a touch along the first clockwise track L1 and the second clockwise track L3 (as shown in FIG. 7) thereon, the clockwise track sensing signals S2 and S2′ (as shown in FIG. 3) are transmitted to the processing unit 14, and then the processing unit 14 switches the display from the first functional page 100 to the second functional page 110, or zooms out the first functional page 100 on the display portion 1111.

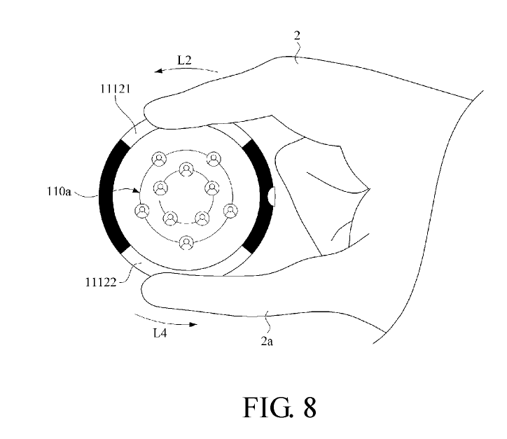

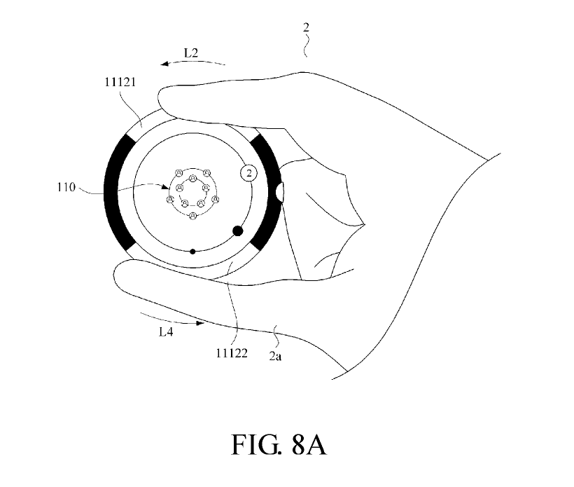

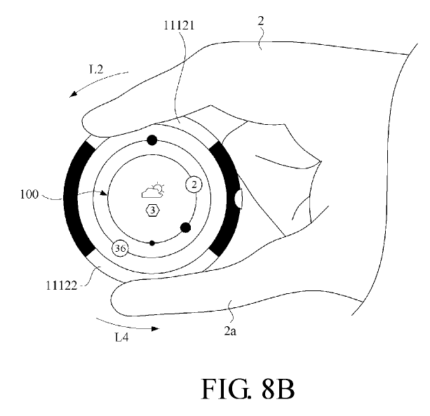

In an embodiment, when the sensors 12 and 13 sense a touch along the first counter-clockwise track L2 and a second counter-clockwise track L4 (as shown in FIG. 8) thereon, counter-clockwise track sensing signals S3 and S3′(as shown in FIG. 3) are transmitted to the processing unit 14, and then the processing unit 14 switches the display from the first functional page 100 to the second functional page (not shown), or the processing unit 14 zooms in the first functional page 100 on the display portion 1111.

FIG. 7 to FIG. 7B are schematic diagrams showing that sensing areas are touched along a first clockwise track and a second clockwise track in an embodiment. As shown in FIG. 7A, the objects 2 touches the sensing area 11121 along the first clockwise track L1, and the object 2a touches the sensing area 11122 along the second clockwise track L3, after the processing unit 14 receives the clockwise track sensing signals S2 and S2′, the processing unit 14 changes the first functional page 100 to the second functional page 110 on the display portion 1111.

As shown in FIG. 7A and FIG. 7B, when the object 2 touches the sensing area 11121 along the first clockwise track L1, and the object 2a touches the sensing area 11122 along the second clockwise track L3, the processing unit 14 zooms out the second functional page 110 to a third functional page 110a of a plurality of the operational pages (in the embodiment, the touch is a continuous operation, the second functional page 110 and the third functional page 110a are taken as an example for illustration) on the display portion 1111. As a result, the applications can be switched, and the page of the application can be zoomed out.

FIG. 8 to FIG. 8B are schematic diagrams showing that sensing areas are touched along a first counter-clockwise track and a second counter-clockwise track in an embodiment. As shown in FIG. 8 to FIG. 8B, to switch to the original first functional page 100, the object 2 touches the sensing area 11121 along the first counter-clockwise track L2, and the object 2a touches the sensing area 11122 along the second counter-clockwise track L4, after the processing unit 14 receives the counter-clockwise track sensing signals S3 and S3′, the display portion 1111 is changed by the processing unit 14 from zooming in the third functional page 110a to the second functional page 110.

Then, the object 2 continuously touches the sensing area 11121 along the first counter-clockwise track L2, and the object 2a continuously touches the sensing areas 11122 along the second counter-clockwise track L4, the processing unit 14 switches the second functional page 110 to the first functional page 100 on the display portion 1111, as a result, the applications can be switched, and the page of the application can be zoomed in.

In embodiments, when the objects 2 and 2a touch the sensing areas 11121 and 11122 and move along the clockwise track or the counter-clockwise track, respectively, the page can be changed, zoomed in or out, which is not limited herein.

In an embodiment, the operation is reverse. When the sensor 12 senses a touch along a first clockwise track L1, and the sensor 13 senses a touch along the second clockwise track L3, the processing unit 14 zooms in the first functional page 100 on the display portion 1111. When the sensors 12 and 13 sense the touch along the first counter-clockwise track L2 and the second counter-clockwise track L4, the processing unit 14 zooms out the first functional page 100 on the display portion 1111.

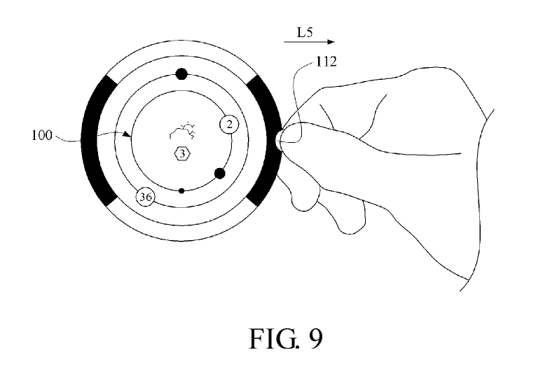

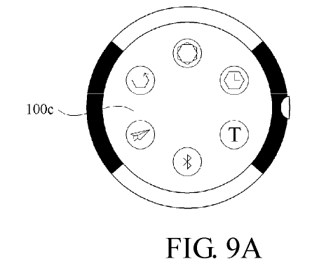

FIG. 9 and FIG. 9A are schematic diagrams showing that a trigger unit is triggered along a moving direction in an embodiment. As shown in FIG. 9 and FIG. 9A, when the trigger unit 112 is triggered along a moving direction L5, the processing unit 14 changed the first functional page 10 to the second functional page 100c of the operational pages on the display portion 1111. In an embodiment, the moving direction L5 is a translation direction. In another embodiment, the movement is rotation. That is, the trigger unit 112 can be pushed and pulled, and rotated to trigger the processing unit 14 to make the display portion 1111 change the display of the first functional page 100 to the display of the second functional page 100c. In an embodiment, the second functional page 100c is a menu page or a setting page, which is not limited herein.

To switch the second functional page 100c back to the first functional page 100, the trigger unit 112 is trigged along a direction reverse to the moving direction L5, which is not limited herein.

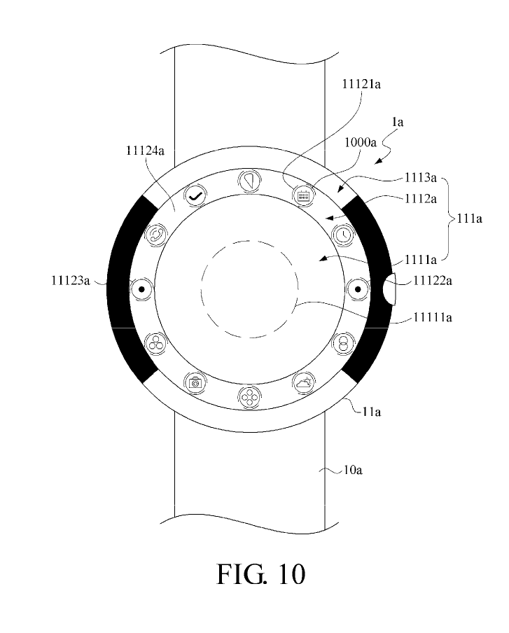

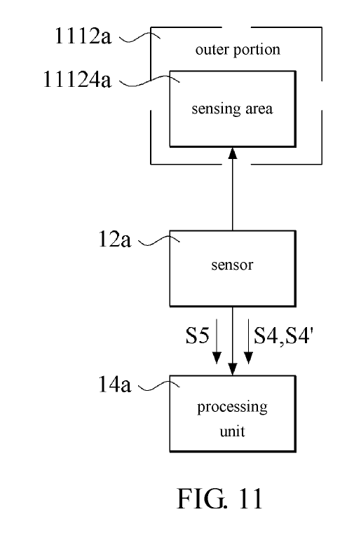

Please refer to FIG. 10 and FIG. 11. FIG. 10 is a top view of a smart watch in an embodiment. FIG. 11 is a block diagram showing a smart watch in an embodiment.

As shown in FIG. 10, in the embodiment, the smart watch 1a includes a watchband 10a, a processing unit 14a and a sensor 12a (in the embodiment, only one sensor is shown). The difference between the smart watch 1 and the smart watch 1a is that the outer portion 1112a of the watch body 11a is not the bezel, the upper surface 111a includes a touch panel surface 1113a, and the display portion 1111a and the outer portion 1112a locates at the touch panel surface 1113a, and the display portion 1111a further includes an operation destination portion 11111a.

The outer portion 1112a includes a plurality of application image portions 11121a (in the embodiment, only one application image portion is shown), an application input portion 11122a, and an application setting portion 11123a. Each application image portion 11121a includes an application image 1000a (such as the application image portion 11121a shown in the figure) which is display at the sensing area 11124a (in the embodiment, the whole outer portion 1112a is the sensing areas, which can be divided into a plurality of the sensing areas)

The application input portion 11122a is configured at one of the sensing areas, and locates between two of the application image portions 11121a (as shown in FIG. 10). The application setting portion 11123a is configured at one of the sensing areas, and locates between two of the application image portions 11121a (as shown in FIG. 10).

The operation destination portion 11111a locates at the center of the display portion 1111a, and the application image portion 11121a, the application input portion 11122a, and the application setting portion 11123a surround the operation destination portion 11111a.

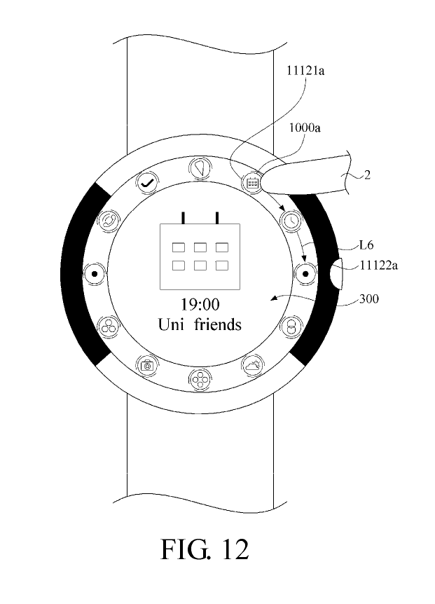

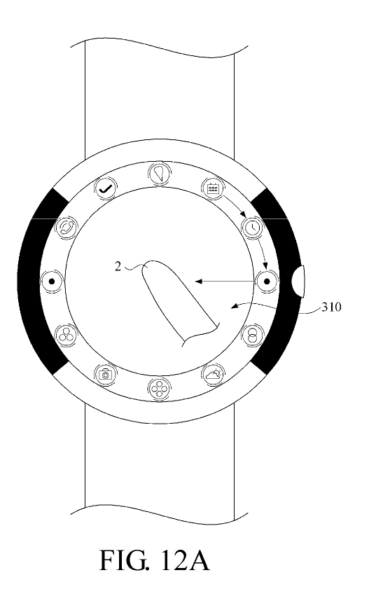

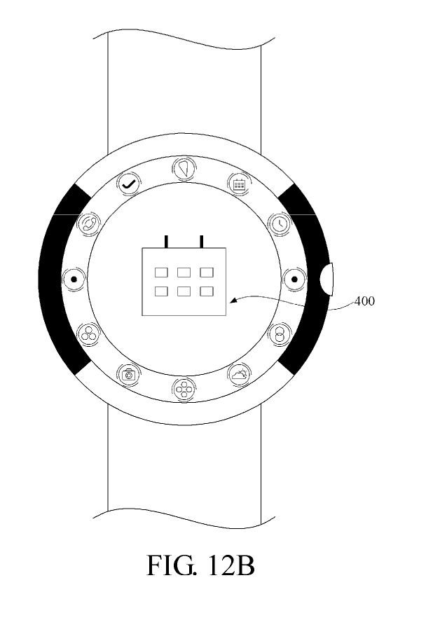

Please refer to FIG. 10, FIG. 11, FIG. 12, FIG. 12A, and FIG. 12B. FIG. 12 to FIG. 12B are schematic diagrams showing that the touch moves to the application input portion along a clockwise operation track and continuously moves to the operation destination portion in an embodiment.

In the embodiment, when one of the sensors 12a senses that one of the application image portions 11121a is touched by the object 2 (as shown in FIG. 12, the application image portion 11121a is taken as an example), and the sensor 12a further senses that the object 2 moves to the application input portion 11122a (as shown in FIG. 12) along the clockwise operation track L6 of the outer portion 1112a (as shown in FIG. 12), and the touch panel surface 1113a (in an embodiment, other sensor are configured inside the touch panel surface 1113a) senses the object 2 moves from the application input portion 11122a to the operation destination portion 11111a (as shown in FIG. 12A), the processing unit 14a changes the display of the first functional page 310 to the display of the application execution page 400 (as shown in FIG. 12B) of the operational pages according to a clockwise operation sensing signal S4 (which is transmitted by the sensor 12a in an embodiment). In an embodiment, the first functional page 310 is a blank page corresponding to that the object 2 moves to the application input portion 11122a, which is not limited herein.

When the sensor 12a sense that one of the application image portion 11121a is touched by the object 2, an image display signal S5 is transmitted to the processing unit 12a to make the processing unit 14a display the application image 300 corresponding to the touched application image portion 11121a on the display portion 1111a. In other words, as shown in FIG. 12, when the object 2 touches the application image portion 11121a, the application image corresponding to the application image portion 11121a is displayed. For example, the object 2 moves from the application image portion 11121a to the next image along the clockwise operation track L6 (the application image corresponding to the next image is displayed at the moment), and then the object moves to the application input portion 11122a (the blank page is displayed at the moment).

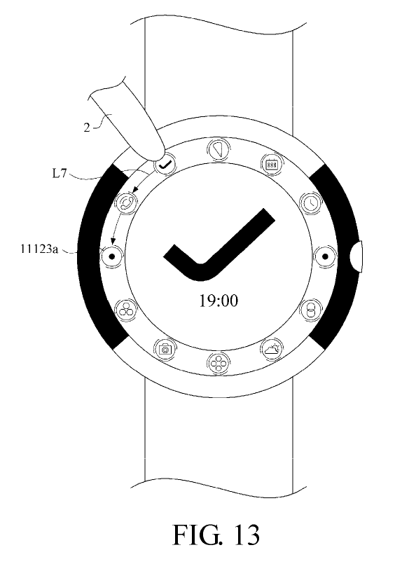

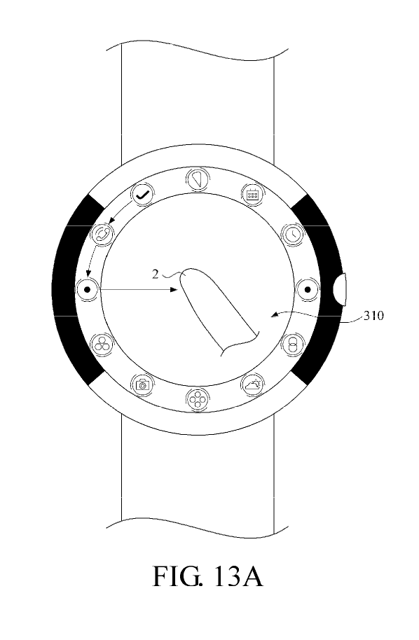

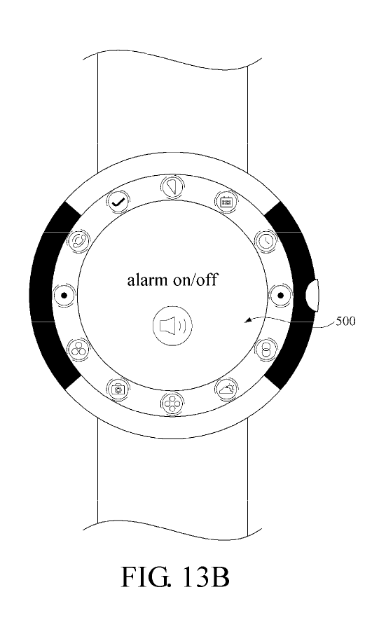

Please refer to FIG. 10, FIG. 11, FIG. 13, FIG. 13A, and FIG. 13B. FIG. 13 to FIG. 13B are schematic diagrams showing that the touch moves to the application setting portion along the counter-clockwise operation track and continuously moves to the operation destination portion in an embodiment.

When the sensor senses that one of the application image portions 11121a is touched by the object 2, and the sensor further senses that the object 2 moves to the application setting portion 11123a along the counter-clockwise operation track L7 of the outer portion 1112a (as shown in FIG. 13), and the touch panel surface 1113a senses that the object 2 moves from the application setting portion 11123a to the operation destination portion 11111a (as shown in FIG. 13), the processing unit 14a switches the display from the first functional page 310 to the display of the application setting page 500 of the operational pages (as shown in FIG. 13B) on the display portion 1111a according to an counter-clockwise operation sensing signal S4′.

When one of the application image portion 11121a is touched by the object 2, the display portion 1111a displays the application image corresponding to the application image portion 11121a. In the embodiment, the operation along the clockwise operation track L6 and the counter-clockwise operation track L7 correspond to the execution or the setting of the application. In another embodiment, the operation along the clockwise operation track L6 and the counter-clockwise operation track L7 correspond to different content of the page, which is not limited herein.

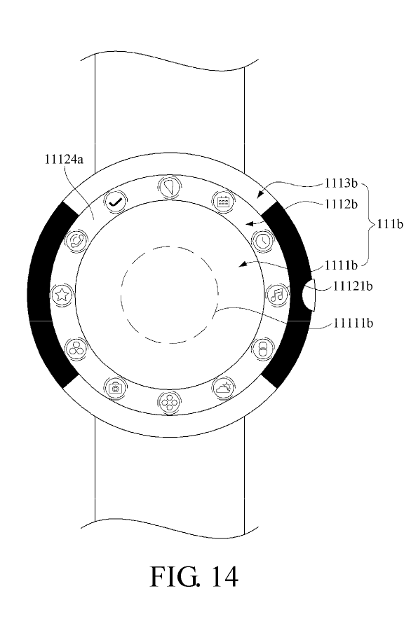

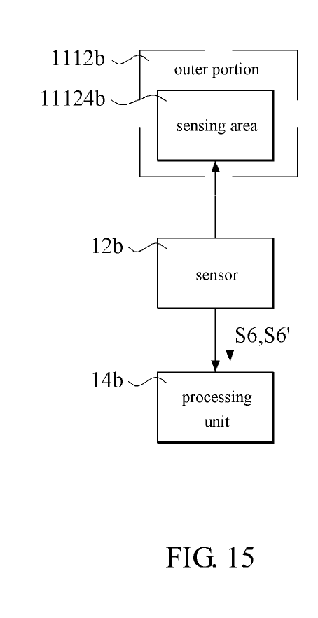

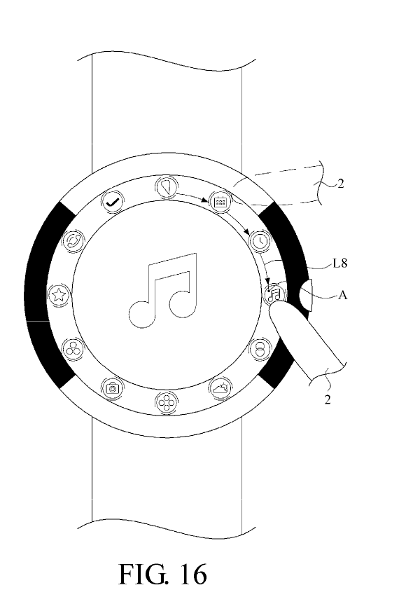

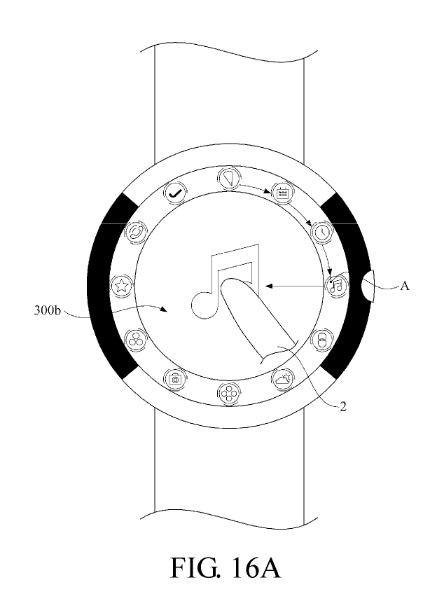

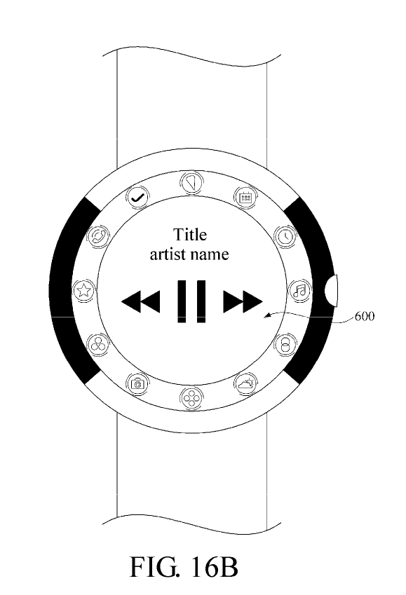

Please refer to FIG. 14 to FIG. 17B. FIG. 14 is a top view of a smart watch in an embodiment. FIG. 15 is a block diagram showing a smart watch in an embodiment. FIG. 16 to FIG. 16B are schematic diagrams showing that the touch moves to the operation end point of the outer portion along the clockwise operation track, and then moves to the operation destination portion in an embodiment.

The upper surface 111b includes a touch panel surface 1113b, and the display portion 1111b and the outer portion 1112b locate on the touch panel surface 1113b. The display portion 1111b further includes an operation destination portion 11111b. The difference between the embodiment in FIG. 14 and the embodiment in FIG. 10 is that the outer portion 1112b only includes a plurality of application image portions 11121b (only one application image portion 11121b is shown) configured at the sensing areas 11124b.

When the sensor 12b (only one sensor 12b is shown) sense that the outer portion 1112b is touched by the object 2 and further senses that the object 2 moves to the operation end point A corresponding to the application image portion 11121b along the clockwise operation track L8 of the outer portion 1112b (as shown in FIG. 16), and further moves from the outer portion operation end point A to the operation destination portion 11111b (as shown in FIG. 16A), the processing unit 14b switches the display of the first functional page 300b to the display of the application execution page 600 corresponding to the application image portion 11121b of the outer portion operation end point A (as shown in FIG. 16B) on the display portion 1111b according to a clockwise operation sensing signal S6 (transmitted from the sensor 12b).

The first functional page 300b corresponds to the application image of the application image portion 11121b. Similar to the above embodiment, when one of the application image portions 11121b is touched by the object 2, the display portion 1111b displays the application image corresponding to the touched application image portion 11121b.

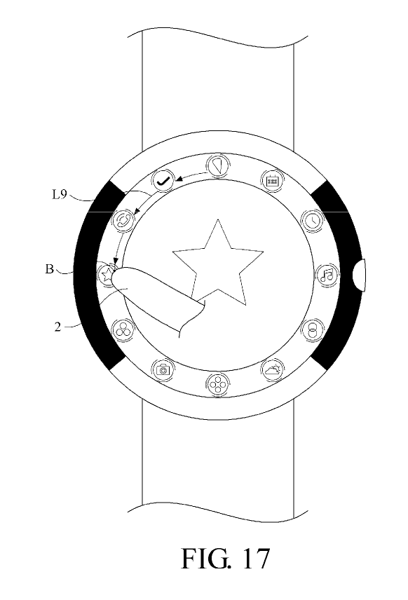

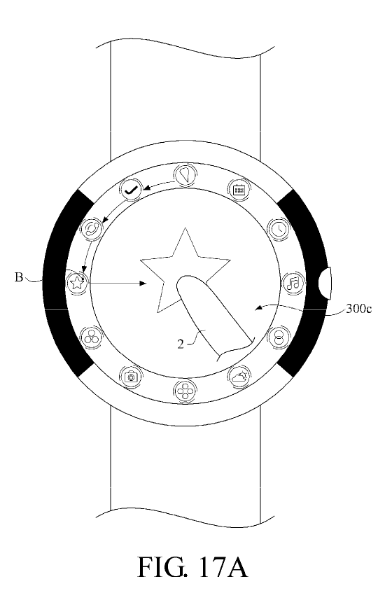

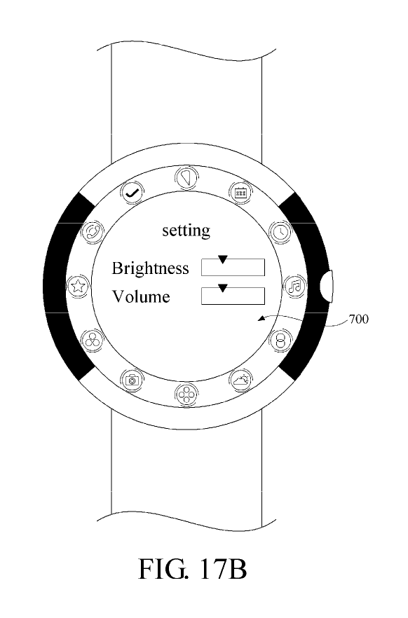

FIG. 17 to FIG. 17B are schematic diagrams showing that the touch moves to the operation end point of the outer portion along an counter-clockwise operation track, and then moves to the operation destination portion in an embodiment.

As shown in FIG. 17 to FIG. 17B, when the sensor 12b senses that the outer portion 1112b is touched by the object 2 and further senses that the object 2 moves to the outer portion operation end point B corresponding to one of the application image portions 11121b along the counter-clockwise operation track L9 of the outer portion 1112b (as shown in FIG. 17), and then moves from the outer portion operation end point B to the operation destination portion 11111b (as shown in FIG. 17A), the processing unit 14b counter-clockwise switches the display of the first functional page 300c to the display of the application execution page 700 corresponding to the application image portion 11121b at the outer portion operation end point B (as shown in FIG. 17B) on the display portion 1111b according to an counter-clockwise operation sensing signal S6′ (transmitted from the sensor 12b).

In an embodiment, the operation along the clockwise operation track L8 and the counter-clockwise operation track L9 correspond to the execution and the setting of applications, or the operation along the clockwise operation track L8 and the counter-clockwise operation track L9 correspond to the change of the content of the display page, which is not limited herein.

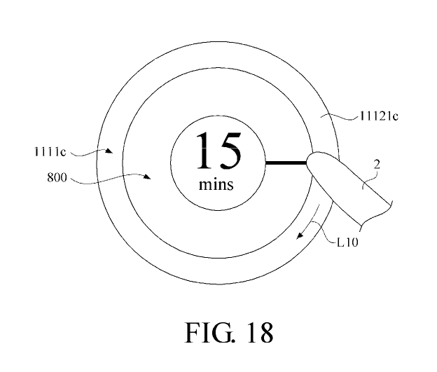

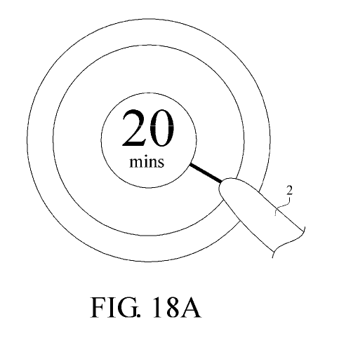

FIG. 18 and FIG. 18A is a schematic diagram showing the time setting in an embodiment. As shown in figures, if the application execution page 800 is a time setting interface, when the object 2 touches the sensing areas 11121c along the clockwise track L10, the processing unit can make the display portion 1111c display the corresponding time.

In sum, when the user operates at a plurality of the sensing areas of the smart watch, the functional pages can be changed according to the sensed track on the sensing areas. Consequently, the operation is more intuitive, simple, and convenient.

Although the invention has been disclosed with reference to certain preferred embodiments thereof, the disclosure is not for limiting the scope. Persons having ordinary skill in the art may make various modifications and changes without departing from the scope of the invention. Therefore, the scope of the appended claims should not be limited to the description of the preferred embodiments described above.

What is claimed is:

1. A smart watch, comprising:
a watch body, having an upper surface comprising:
a display portion, displaying a first functional page; and
an outer portion, configured at periphery of the display portion and having a plurality of sensing areas;
a plurality of sensors, correspondingly configured at each of the sensing areas, wherein when the sensors sense that one of the sensing areas is touched along a first clockwise track or a first counter-clockwise track, a touch signal is transmitted; and
a processing unit, configured at the watch body and electrically connected to the sensors, for receiving the touch signal and changing the first functional page accordingly.

2. The smart watch according to claim 1, wherein the outer portion is a bezel and has a height higher than that of the display portion.

3. The smart watch according to claim 2, wherein the height of the bezel is gradually decreased from an outer edge of the outer portion towards an inner edge of the outer portion.

4. The smart watch according to claim 1, wherein when the processing unit receives the touch signal, the display portion is changed by the processing unit from the first functional page to a second functional page.

5. The smart watch according to claim 1, wherein when the sensors sense a touch along the first clockwise track or a second clockwise track, a clockwise track sensing signal is transmitted to the processing unit to zoom out or zoom in the first functional page on the display portion.

6. The smart watch according to claim 1, wherein when the sensors sense a touch along the first counter-clockwise track or a second counter-clockwise track, a counter-clockwise track sensing signal is transmitted to the processing unit to make the processing unit zoom in or zoom out the first functional page on the display portion.

7. The smart watch according to claim 1, wherein a trigger unit is configured at a side wall of the watch body, and the trigger unit is electrically connected to the processing unit, when the trigger unit is triggered along a moving direction, the processing unit changes the first functional page to the second functional page on the display portion.

8. The smart watch according to claim 1, wherein the upper surface includes a touch panel surface, the display portion and the outer portion locates on the touch panel surface, the display portion further includes an operation destination portion, and the outer portion includes:
a plurality of application image portions configured at each of the sensing areas; and
an application input portion configured at one of the sensing areas and between two adjacent application image portions of the application image portions;
when the sensors sense that one of the application image portions is touched by an object and continuously sense that the object moves to the application input portion along a clockwise operation track of the outer portion, and the touch panel surface senses that the object moves from the application input portion to the operation destination portion, the processing unit changes the first functional page to an application execution page of the operational pages on the display portion according to a clockwise operation sensing signal.

9. The smart watch according to claim 1, wherein the upper surface includes a touch panel surface, the display portion and the outer portion are configured on the touch panel surface, the display portion further includes an operation destination portion, and the outer portion includes:
a plurality of application image portions displayed at the sensing areas, respectively;
an application setting portion configured at one of the sensing areas and between two adjacent image portions of the application image portions;
when the sensors sense that one of the application image portions is touched by an object, and continuously sense that the object moves to the application setting portion along an counter-clockwise operation track of the outer portion, and when the object moves from the application setting portion to the operation destination portion is sensed on the touch panel surface, the processing unit changes the first functional page to an application setting page of the operational pages on the display portion according to an counter-clockwise operation sensing signal.
